(19) United States
(12) Patent Application Publication
(10) Pub. No.: US 2010/0155448 A1
(43) Pub. Date: Jun. 24, 2010

(54) NAIL GUN CARTRIDGE AND DRIVER AND STUD FINDER INTEGRATED WITH NAIL GUN

(76) Inventor: James Murtha, Sayville, NY (US)

Correspondence Address: KATTEN MUCHIN ROSENMAN LLP, 575 MADISON AVENUE, NEW YORK, NY, 10022-2585, US

(21) Appl. No.: 11/993,284

(22) PCT Filed: Jun. 26, 2006
(86) PCT No.: PCT/US06/24715

§ 371 Date: Dec. 20, 2007

Related U.S. Application Data
(60) Provisional application No. 60/693,693, filed on Jun. 24, 2005.

(51) Int. Cl. B27F 7/00

(52) U.S. Cl. 227/5; 227/139

(57) ABSTRACT

A nail gun is configured with a guide channel for receiving a plurality of preset nails each of which is provided with a generally frustoconical sleeve that is traversed by a nail shaft and surrounds a nail head. The guide channel is configured with a guide surface extending substantially parallel to respective opposing peripheral segments of the sleeve. The nail gun further has a driver bit configured with a bottom pedestal dimensioned to impact upon the nail head while avoiding contact with the top face of the sleeve. The nail gun also includes a stud finder facilitating coupling between the work piece and a stud.

### CROSS-REFERENCE TO RELATED APPLICATION

This application claims priority to U.S. Provisional Application Ser. No. 60/693,693 filed on Jun. 24, 2005 and fully incorporated herein by reference.

### BACKGROUND OF THE INVENTION

1. Field of the Invention

The present invention relates to improvements to air guns and specifically to nail guns.

2. Discussion of the Prior Art

Many of known nail guns are not adapted to house one or more preset nails in a cartridge compartment nor to drive preset nails using a driver tip. As a result, the nail guns as, for example, disclosed by U.S. patent application Ser. No. 10/894,467, the disclosure of which is hereby incorporated by reference in its entirety, may be not as efficient as one would desire.

Nail guns known in the art comprise a cartridge compartment adapted to house a nail that is substantially tubular and configured with a sharpened tip and a flattened nail head. Typically, each of the preset nails further includes a flattened head and a uniformly configured shaft which extends from the head. Standard nails may be inefficient in certain situations requiring that the nails have an irregular configuration. One of numerous examples of the irregularly configured nails is disclosed in the above-mentioned U.S. patent application Ser. No. 10/894,467 and configured with a generally frustoconical sleeve. The sleeve is provided with a throughbore traversable by a nail shaft so that the sleeve's largest end is disposed contiguous to the nail head. The existing nails guns are not configured to accommodate nails provided with respective sleeves.

Most residential and some commercial construction is stick built, meaning that wall columns and floors are assembled on site from cut lumber. Walls are typically framed using 2″×4″ lumber, called studs, oriented vertically and spaced apart from each other. Sheetrock, also called gypsum board, or other wall material is then nailed to the studs.

To properly nail the sheetrock, it is imperative to locate the studs since the sheetrock can only be anchored to the studs. Typically, a separate stud finder is used to locate the studs. However, this requires that the carpenter holds the sheetrock, finds the stud using the finder and then marks the location. After marking the location, the carpenter changes tools and nails the sheetrock to the stud at the marked locations. The currently used method is, thus, both time-ineffective and inconvenient due to a lengthy procedure of locating studs.

A need, therefore, exists for a nail gun that obviates the drawbacks of the known nail gun structures.

Another need exists for a nail gun that is configured with a cartridge assembly housing a strip of preset nails.

Still another need exists for a nail gun that has a nail driver configured to engage a nail provided with a sleeve so that the nail and sleeve can be simultaneously advances in a driving direction.

A further need exists for a nail gun that is configured with an automatic stud locator.

### SUMMARY OF THE INVENTION

These needs are satisfied by the invention. In accordance with one aspect of the invention, a nail gun is formed with a body which has a barrel. The nail gun further has a cartridge unit provided in the body and configured to store a plurality of preset nails, which are sequentially deliverable to the barrel. Each of the nails has a nail head, a nail shaft extending from the head and a sleeve threaded on the nail shaft and provided with a seat which receives the nail head. The sleeve has a generally frustoconical shape providing a reliable bond between a work piece and a driven nail. The cartridge unit has spaced opposing walls provided with respective beveled portions which define therebetween a frustoconically shaped region that is dimensioned to receive the sleeve of the nail.

In accordance with another aspect of the invention, the inventive nail gun also has a driver unit provided with a driver bit. Since the sleeve surrounds the nail head and is capable of displacing relative to the nail, it is necessary that the driver bit be configured to accurately drive the nail. Accordingly, the driver bit has a relatively narrow bottom portion or a pedestal configured to impact only upon the nail head resting against the sleeve, but not the sleeve itself.

In accordance with a further aspect of the invention, the inventive nail gun has a stud finder mounted to the gun's body. The stud finder is provided with a stud sensor operative to determine a relative distance between itself and a stud and generate a signal upon determining the distance. The signal is processed by a logic operative to selectively energize one of multiple light indicators which are differently colored to correspond to different distance ranges between the sensor and the stud. In addition, the logic is operative to energize an audio-tone indicator operative to generate a plurality of differently pitched sound signals also corresponding to respective distances between the sensor and the stud.

### BRIEF DESCRIPTION OF THE DRAWINGS

The above and other features and advantages will become more readily apparent from a detailed description taken in conjunction with the following drawings, in which:

FIG. 1 is an elevated side view of a nail gun configured in accordance with the invention;

FIG. 2 is a perspective view of a cartridge of the nail gun of FIG. 1 configured to house a strip of nails each of which includes a nail shaft, a nail head and a sleeve extending from the nail head to the nail shaft.

FIG. 3 is a diagrammatic front view of a channel of the cartridge of FIG. 2 and a nail received in the channel.

FIG. 4 is an elevated side view of the nail gun of FIG. 1 showing a tip of a nail driver.

FIGS. 5A and 5B are bottom and side views, respectively, of a nail driver configured in accordance with one embodiment of the invention;

FIGS. 6A and 6B are bottom and side views, respectively, of a nail driver configured in accordance with a further embodiment of the invention;

FIG. 7 is a side view :of a nail gun configured with a stud finder in accordance with one embodiment of the invention;

FIG. 8 is a top view of the nail gun of FIG. 7; and

FIG. 9 is a side view of a nail gun configured with a stud finder in accordance with a further embodiment, of the invention

### SPECIFIC DESCRIPTION

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of Convenience and clarity only, directional terms, such as top, bottom, up and down may be used with respect to the drawings. These and similar directional terms should not be construed to limit the scope of the invention in any manner.

With reference to FIGS. 1-3 of the present invention, the inventive nail gun 10, configured, for example, as an air gun, includes a cartridge assembly 12 shaped and dimensioned to removably receive a strip of preset nails 14. The nails 14 are grouped and joined together by at least one breakable holding element 16, better seen in FIG. 2. The nail gun 10 is operative to sequentially deliver each of the nails to a barrel 18 and subsequently drive the delivered nail into a work piece, as will be explained hereinbelow.

The nail gun 10 includes a pressurized air chamber (not shown) in a compressed air body 20. The body 20 is provided with a fitting (not shown) for connection to an air hose leading to a source of pressurized air and a cylinder housing 22 with an operating cylinder and piston drive rod assembly or unit configured to impact and guide a nail along barrel 18. When a trigger 25 is pulled, a charge of pressurized air is admitted into the operating cylinder driving the piston or drive rod against the nail to drive it along barrel 18 into the work piece. A nail-actuating unit 24, diagrammatically shown in FIG. 2 and typically including, for example, a spring-biased follower or any other actuating mechanism urges succeeding nails in cartridge 12 forward into barrel 18.

The nails 14, as shown in FIG. 3, each include a nail shaft 26 and a head (not shown) that is disposed in a sleeve 30 displaceably joined to the nail in a manner such as the one proposed by U.S. patent application Ser. No. 10/894,467. In particular, sleeve 30 has a flared body 28 that is relatively narrow at the bottom and wider at the top portion. The sleeve 30 has a throughbore configured to be threaded onto nail shaft 26 so that the nail head rests in the top portion of sleeve 30. The flared or frustoconical shape of sleeve 30 forms a plug that assures a reliable bond to the work piece. The sleeve 30 may come in different sizes and may serve as a depth adapter which is drawn directly into the work piece so as to prevent a nail from being driven beyond the work piece at the desired distance. Preferably, sleeve 30 is disposed at approximately the top third of nail 14.

The breakable element or elements 16 (FIG. 2) preferably comprise an adhesive paper provided with a row of holes each of which is shaped and dimensioned to reliably support a nail. As the nail head is impacted in barrel 18, the portion of the paper supporting the impacted nail is separated from the rest of the breakable element. To facilitate separation between adjacent regions of the breakable element, the paper may be provided with a plurality of perforated areas (not shown). Joined together by breakable element 16, nails 14 define a nail strip appropriately sized to be loaded into cartridge 12.

In accordance with one aspect of the present invention, since sleeve 30 of nail 14 is considerably wider then the remainder of the nail, a compartment 32 of cartridge 12 is widened in a manner shown in FIGS. 2 and 3. Therein, compartment 32 is widened at the top and a channel 34 is created for sleeve 30 of nails 14. The channel comprises a double angle that is disposed on each side of cartridge 12 to just below the sleeve and then the normal profile of the cartridge is maintained. In particular, compartment 32 is configured with a pair of top wall portions or bevels 36 diverging from one another towards the top of the compartment and each generally extending substantially parallel to an opposing peripheral segment of sleeve 30. Preferably bottom and top portions 38, 40, (FIG. 3) respectively, of each bevel 36 are inclined relative to the intermediary wall portion in opposite directions.. The top portion 40 extends angularly outwards from the intermediary wall portion, while bottom portion 38 is beveled inwards to create a region just below the bottom of sleeve 30 and narrow enough to guide sleeve 30 with nail 14 along the desired linear path in compartment 32. It should be then appreciated that the angles of bevels 36 are configured so that channel 34 is dimensioned to permit movement of nail 14 along cartridge compartment 32 into barrel 18 in a reliable manner. The side walls 42 of compartment 32 extend parallel to one another and define the bottom region of channel 34 (FIG. 2) which is shaped and dimensioned to receive nail shafts 26 of respective nails 14.

While compartment walls 36 have been disclosed as generally diverging from one another, an artisan can readily discern that other profiles of compartment 32 may be configured provided that the walls generally extend parallel to the outer periphery of sleeve 30, which, thus, may be different from frustoconically-shaped.

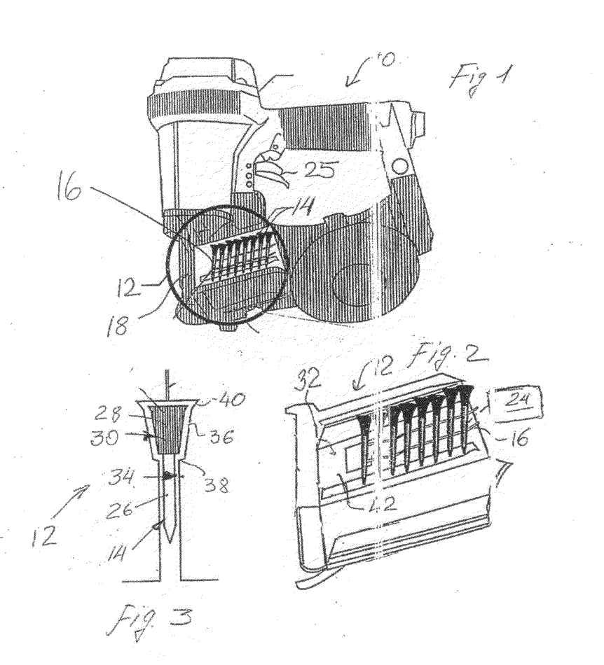

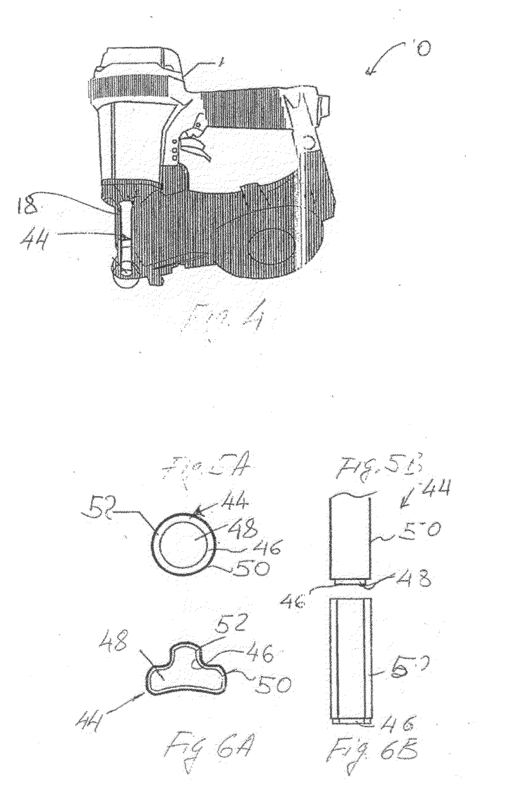

FIGS. 4, 5A, 5B and 6A and 6B show another aspect of the invention directed to a particular configuration of a nail drive unit having a drive rod or driver bit 44. The driver bit 44 is disposed in barrel 18 of gun nail 10. Returning for a moment to the preset nail of FIGS. 1-3, sleeve 30 and nail 14 are capable of displacing relative to one another in response to a force applied by driver bit 44. To prevent this undesirable displacement, driver bit 44 is configured with a step down step region to create a pedestal 46 (FIGS. 5A and 6A) that has a narrower bottom portion 48 than the cross-sectional area of an unmodified portion 50 of the driver. A rim 52 (FIGS. 5B and 6B) defines an area of driver bit 44 between the peripheral surfaces of pedestal 46 and unmodified portion 50, respectively. The bottom of pedestal 46 has a cross-section substantially identical to the cross-section of the nail head and, thus, is prevented from contacting the top face of sleeve 30. Since the nail head rests in the top region of sleeve 30, nail 14 and sleeve 30 are driven simultaneously into the work piece or target in response to a force applied by driver bit 44.

The shapes of driver bit 44 may include a circularly shaped cross-section, as shown in FIG. 5B, and a substantially stylized T-shaped cross-section, as illustrated in FIG. 6B. Other shapes may include a variety of polygonally shaped, oval-shaped and other regular and irregular shapes as long as the bottom of pedestal 44 does not impact upon the top face of sleeve 30. In contrast to the inventive driver bit 44, a typical driver bit does not have the pedestal as described above.

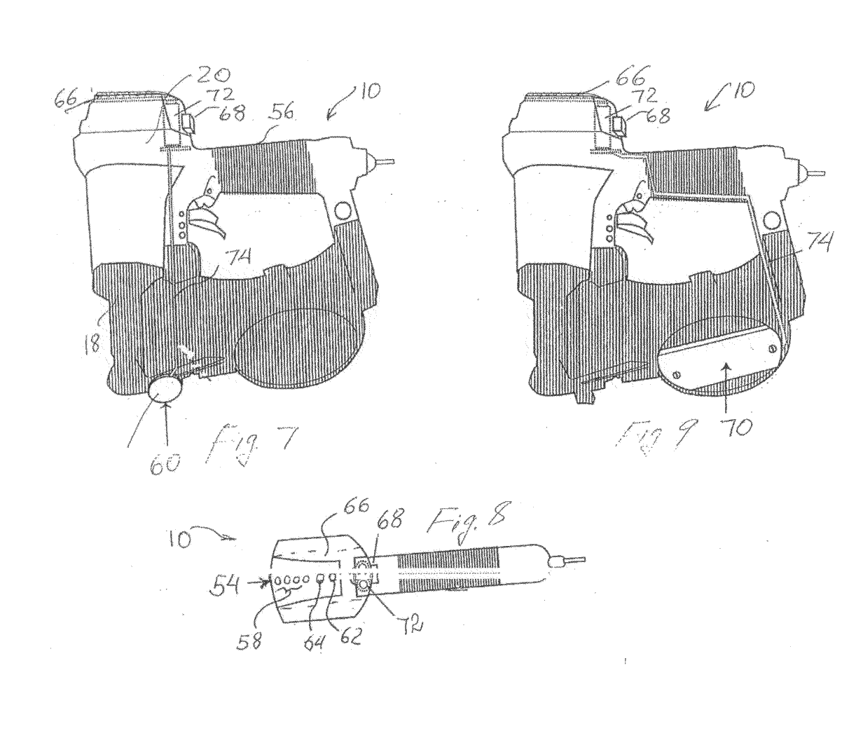

Turning now to FIGS. 7-8, a further aspect of inventive nail gun 10 includes a stud finder that is integrated with the nail gun to allow the operator to more readily and conveniently find a stud that is obscured by a work piece, such as sheetrock, during nailing. The stud finder includes a display 54, as illustrated in FIG. 8, and a stud sensor 60, as illustrated in FIG. 7. The display 54 is preferably disposed away from a handle 56 (FIG. 7) of nail gun 10 so that it is readily visible during the operation of nail gun 10. A preferred location is on the top of housing 20 of nail gun 10.

The display 54 includes a series of indicator lights 58 that progress along a color scale, such as green, yellow, orange to light-red, to indicate the relative proximity of nail gun 10, or more precisely stud sensor 60 (FIG. 7) to the stud. When sensor 60 is away from a stud, the green indicator light, for example, is lit. The closer the sensor comes to stud the lights will progress toward light-red according to a predetermined routine. When sensor 60 is disposed over the center of the, stud, a stud confirmation light 62 (FIG. 8) will turn on. Typically, such a light is bright red.

An audio tone indicator 64 (FIG. 8) in display 54 may indicate a particular proximity to the stud, such as its edge, by one tone or intensity and a have a more pronounced tone or intensity as sensor 60 is disposed over the center of the stud.

The stud finder also includes a circuit board 66 (FIG. 8) that is configured with means for determining the location of the stud in response to a signal generated by sensor 60 (FIG. 7). Known methods of finding a stud include magnetic location of nails, determination of mass density, or sound. Thus, circuit board 66 may include a logic circuit for detecting magnetic properties already embedded into the stud or using a variation in density below the surface such as sheet rock. The stud finder preferably also includes means for calibration that are set, for example, by a memory switch 68.

The stud finder may be powered by any convenient means, but operation by battery power is preferred, especially when the nail gun is pneumatically powered. Therein, a battery compartment 72 is conveniently disposed on the nail gun, where two or more AA batteries or other type of batteries power the circuit board, sensor, and display unit. An on/off switch or an automatic on-sensor may also be conveniently disposed on the nail gun.

The stud sensor of FIG. 7 is configured as a flat plate in electronic communication via a wiring harness 74 with circuit board 66, is disposed in the bottom of nail gun 10 near barrel 18 of the gun.

FIG. 9 illustrates a further embodiment of the stud finder. While a display in this embodiment is configured identically to display 54, as a shown in FIG. 8, a stud sensor 70 is located under cartridge compartment 32 and coupled to circuit board 66 by harness 74 extending though the rear portion of nail gun 10.

Both locations of stud sensors 60 and 70, respectively, conveniently allow the carpenter to find the stud as he prepares to nail. Once the location is determined, it no longer needs to be marked, but rather the carpenter can proceed to drive a nail. Consequently, the process of nailing is expedited. Other improvements now know or to be developed with respect to stud finders is within the scope of the invention of a stud finder integrated with a nail gun.

Although the present invention is disclosed with respect to air guns, and specifically to nail guns using pneumatic air pressure it also within the scope of the present invention to use nail guns that are known in the art and are powered by other means, such as electric and hydraulic means, or by means yet to be invented. For example, nails guns may be powered by a battery or household AC current or use combustion. Furthermore, it is known in the art to use nail guns wherein the nails include a small explosive charge akin to a bullet. These and nail guns that are to be developed are intended to be within the scope of the invention. While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A nail gun comprising:
a body provided with a barrel having a discharge end;
a cartridge unit in the body, the cartridge unit being configured to store a plurality of preset nails sequentially deliverable to the barrel, the cartridge unit having spaced opposing walls, the opposing walls having respective beveled portions defining therebetween a frustoconically shaped region of a guide channel for guiding the nails towards the barrel; and
a driver unit operative to drive each of the delivered preset nails along the barrel through the discharge end into a work piece.

2. The nail gun of claim 1, wherein the frustoconically shaped region of the guide channel is configured to receive a top end of each of the plurality of preset nails, the beveled portions of the opposing walls of the guide channel diverging from one another towards a top of the body.

3. The nail gun of claim 2, wherein the opposing walls further have respective straight portions extending from the beveled portions parallel to one another towards a bottom of the body, the straight portions of the respective walls being spaced from one another so as to define a bottom region of the guide channel configured to receive a nail shaft of each of the preset nails.

4. The nail gun of claim 2, wherein each of the beveled portions extends substantially parallel to an opposing peripheral segment of the top end of the nail, the top end of the nail being configured with a frustoconically shaped sleeve threaded on a nail shaft and supporting a nail head.

5. The nail gun of claim 3, wherein the guide channel is configured so that the beveled and straight wall portions are spaced from each of the plurality of present nails.

6. The nail gun of claim 2, wherein the driver unit comprises a driver bit displaceable in the barrel, the driver bit being configured with a relatively wide top portion and a relatively narrow bottom portion configured to impact upon the top end of the nail so as to drive the nail into the work piece.

7. The nail gun of claim 6, wherein an outer periphery of the bottom portion of the driver bit substantially conforms to an outer edge of a nail head of the nail, a bottom of the top portion of the driver bit being spaced from the top end of the nail while the bottom portion of the driver bit impacts upon the head of the nail.

8. The nail gun of claim 6, wherein the bottom portion of the driver bit has a shape selected from the group consisting of a circularly-shaped cross-section., stylized T-shaped cross-section, and polygonally shaped cross-section.

9. The nail gun of claim 6, wherein the driver unit further comprises an actuator operative to displace the driver bit, the actuator being selected from a group consisting of a pneumatic actuator, hydraulic actuator and electrical actuator.

10. The nail gun of claim 1, further comprising a nail-actuating unit configured to sequentially drive the plurality of the nails along the cartridge unit into the barrel, the plurality of nails being coupled to one another by a flexible element provided with a plurality of breakable regions.

11. The nail gun of claim 1, further comprising a stud finder unit configured with:
a stud sensor operative to determine a relative proximity of the stud sensor to a stud and generate a signal upon the determination,
a plurality of light indicators,
an audio-tone indicator, and
a circuit board configured to receive the signal from the stud sensor and selectively control the array of light indicators, wherein the array of light indicators is configured as a color-coded system in which differently colored lights correspond to respective remote proximity, medium, proximity and close proximity of the stud sensor to the stud, the circuit board being operative to control the audio-tone indicator generating differently pitched audio signals corresponding to the respective remote, medium and close proximities.

12. The nail gun of claim 11, wherein the circuit board circuit includes a logic circuit for detecting magnetic properties of the stud or a variation in density between a region of the work piece juxtaposed with the stud and a region of the work piece spaced from the stud in response to the signal generated by the stud sensor.

13. The nail gun of claim 11, wherein the stud finder further comprises means for calibration set by a memory switch.

14. The nail gun of claim 11, wherein the plurality of light indicators, audio-tone indicator and circuit board are located on a top of the body.

15. The nail gun of claim 11, wherein the stud sensor is flat and located on a bottom of the body adjacent to the barrel.

16. The nail gun of claim 11, wherein the stud sensor is flat and located on a bottom of the body under the cartridge unit.

17. A nail gun comprising:
a body provided with a barrel having a discharge end;
a cartridge unit in the body, the cartridge unit being configured to store a plurality of preset nails sequentially deliverable to the barrel;
a driver unit mounted to the body and operative to drive each of the delivered preset nails along the barrel through the discharge end into a work piece; and
a stud finder unit operative to locate a stud juxtaposed to a region of the work piece intended to be nailed to the stud by at least one of the plurality of nails.

18. The nail gun of claim 17, wherein the cartridge unit has opposing spaced walls, the opposing walls having respective beveled portions defining therebetween a frustoconically shaped region of a guide channel for receiving a top end of each of the plurality of nails and for guiding the nails towards the barrel.

19. The nail gun of claim 18, wherein each of the beveled portions extends substantially parallel to an opposing peripheral segment of the top end of the nail, the top end of nail being configured with a frustoconically shaped sleeve threaded on the nail shaft and supporting a nail head aligned with the driver unit in the barrel.

20. The nail gun of claim 19, wherein the guide channel is configured so that the beveled portions are spaced from the respective opposing segments of the top end of the nail.

21. The nail gun of claim 19, wherein the driver unit comprises a driver bit displaceable in the barrel, the driver bit being configured with a relatively wide top portion and a relatively narrow bottom portion, the relatively narrow bottom portion being configured to impact upon the top end of the nail so as to drive the nail into the work piece.

22. The nail gun of claim 21, wherein an outer periphery of the bottom portion of the driver bit substantially conforms to an outer edge of a nail head of the nail and a bottom of the top portion of the driver bit is spaced from a sleeve threaded on a nail shaft and surrounding the nail head as the nail head is impacted upon by the bottom portion of the driver bit.

23. The nail gun of claim 21, wherein the bottom portion of the driver bit has a shape selected from the group consisting of a circularly-shaped cross-section, stylized T-shaped cross-section, and polygonally shaped cross-section.

24. The nail gun of claim 23, wherein the driver unit further comprises an actuator operative to displace the driver bit, the actuator being selected from a group consisting of a pneumatic actuator, hydraulic actuator and electrical actuator.

25. The nail gun of claim 17, further comprising a nail-actuating unit configured to sequentially drive the plurality of the nails along the cartridge unit into the barrel, the plurality of nails being coupled to one another by a flexible element provided with a plurality of breakable regions.

26. The nail gun of claim 17, wherein the stud finder comprises:
a stud sensor mounted to a bottom of the body, the stud sensor being operative to determine a relative distance between the sensor and the stud and generate a signal upon determining the distance, and
a plurality of light indicators located on a top of the body,
an audio-tone indicator located next to the plurality of light indicators on the top of the body, and
a circuit board on the top of the body and configured to receive the signal from the stud sensor and selectively energize the array of light indicators, wherein the array of light indicators is configured as a color-coded system in which differently colored lights correspond to respective remote proximity, medium proximity and close proximity of the stud sensor to the stud, the circuit board being operative to energize the audio-tone indicator operative to generate a plurality of different pitches which correspond to the respective remote, medium and close proximities between the stud sensor and the stud.

27. The nail gun of claim 26, wherein the circuit board circuit includes a logic circuit for detecting magnetic properties of the stud or a variation in density between the region of the work piece juxtaposed with the stud and a region of the work piece spaced from the stud.

28. The nail gun of claim 26, wherein the stud finder further comprises means for calibration set by a memory switch.

29. The nail gun of claim 26, further comprising a confirmation position light indicator energized by a signal from the circuit board upon determining the close proximity of the stud sensor to the stud.

30. The nail gun of claim 26, wherein the stud sensor is mounted to the bottom of the body proximate to the barrel or remote from the barrel under the cartridge unit.
